(19) United States
(12) Patent Application Publication
(10) Pub. No.: US 2011/0120413 A1
(43) Pub. Date: May 26, 2011

(54) THROTTLE BODY FUEL DISTRIBUTION ASSEMBLY

(75) Inventors: Corey RUNIA, Byhalia, MS (US); Brian REESE, Collierville, TN (US)

(73) Assignee: COMPETITION CAMS, INC., Memphis, TN (US)

(21) Appl. No.: 12/623,702

(22) Filed: Nov. 23, 2009

(51) Int. Cl. F02D 9/08

(52) U.S. Cl. 123/337

(57) ABSTRACT

A throttle body fuel distribution assembly includes a throttle body assembly having a throttle body housing and a throttle bore for inducting an airflow, a fuel injector coupled to the throttle body assembly, and a fuel dissemination device for dispersing fuel sprayed by the fuel injector into the airflow through the throttle bore. In one variation, a throttle body fuel distribution assembly includes a throttle valve assembly for controlling the airflow through the throttle bore. In some variations, the fuel spray is diverted in a direction resistive to the direction of the airflow through the throttle bore. In yet another aspect, a throttle body injection system for an internal combustion engine includes a throttle body assembly having an air conduit, an injector assembly coupled to the throttle body assembly, and a fuel deflector for deflecting fuel into the airflow.

### BACKGROUND OF THE INVENTION

1. Field of the Invention

Aspects of the present invention relate to a throttle body fuel distribution assembly for internal combustion engine applications and methods of assembly and use thereof, and in particular to methods, systems, and devices for providing an air intake and fuel distribution assembly for engines that mechanically injects, forces, or meters fuel into an intake manifold or cylinder head.

2. Background of the Technology

Internal combustion engines have conventionally relied on carburetors to provide the necessary mixture of fuel into the airflow supplied to the various cylinders. Intake manifolds are used to draw air through the carburetor, with the acceleration of airflow through the carburetor and intake manifold providing the mechanism for pulling fuel into the airflow stream. A carburetor relies upon a venturi effect to draw fuel into the airflow. The pressure difference created by the venturi in a carburetor emulsifies the fuel while forcing the air-fuel mixture into the airflow. The fuel is automatically metered by the airflow through the carburetor, with greater airflow creating a higher pressure difference across the venturi, resulting in a greater draw of fuel. Although carburetors typically provide even fuel distribution to multiple cylinders when the engine is operating under normal conditions, a carburetor has certain drawbacks, including poor or inefficient operation under cold start conditions or when operating in extreme hot or cold ambient air temperatures, and unreliable response to rapid throttle transitions, for example.

Fuel injection has replaced carburetors on many engines as the mechanism for supplying fuel directly into the air intake supplied to the various cylinders. In typical fuel injection systems, fuel is forced or sprayed into the airflow downstream from a throttle body, which is used to regulate or meter the airflow. Electronic fuel injection, for example, relies on an electronic control unit to collect data from a variety of sensors to accurately control the opening of the throttle valve, while also controlling the distribution of fuel through an electronically actuated fuel injector. Fuel injection is often favored, for example, because of a carburetor's restrictive impact on the design of the air intake components. By generally permitting increased airflow to the engine's cylinders, whether through an intake manifold or directly to each cylinder, fuel injection may be used to generate increased power, efficiency and responsiveness. Moreover, use of fuel injection permits more precise control of the air and fuel metering during startup conditions and extreme ambient operating temperatures, while allowing for increased responsiveness to quick changes in the throttle demand.

Throttle body injection (TBI) is a term often used to describe the method of combining a fuel injection capability with a carburetor type air intake. TBI often permits an engine with a carburetor to be replaced with a TBI system to gain the benefits of having a fuel injection capability. TBI systems incorporate a fuel injector directly into the throttle body mounted on an intake manifold. The fuel injector sprays fuel directly into the intake stream, which is often directly into the intake manifold. Uneven distribution of fuel into the intake stream is often the result, with the air-fuel ratio to any particular cylinder being uneven and unpredictable. With some cylinders receiving an airflow with a higher air-fuel ratio, while other cylinders receive an airflow having a lower air-fuel ratio, the result is often poor engine performance or resulting damage to engine components.

There is an unmet need in the prior art for a throttle body injection system that incorporates an effective fuel distribution technology to ensure an even and effective distribution of injected fuel into the intake air flow to the cylinders of an internal combustion engine.

### SUMMARY OF THE INVENTION

Aspects of the present invention include features for providing efficient and effective fuel distribution into the air intake of an internal combustion engine, and in particular, for providing an improved throttle body injection system.

Aspects of the present invention enhance the performance of a throttle body injection system by providing a fuel dissemination device, for example, such as fuel distribution pins or other suitable fuel dissemination feature that diverts, deflects, or otherwise distributes the fuel spray from a fuel injector to effectively disperse fuel droplets throughout the intake airflow to the cylinders of an internal combustion engine. In some aspects, the fuel distribution pins are insertable into channels provided in the throttle body housing.

Exemplary features usable in accordance with aspects of the present invention include a throttle body assembly that has a throttle bore, wherein a throttle valve assembly controls the airflow through the throttle bore toward the dispersed fuel droplets. One feature for dispersing the fuel spray, in accordance with some variations of the present invention, may involve positioning a fuel dissemination device below the throttle valve assembly to divert the fuel spray in a direction transverse or against a direction of the airflow through the throttle bore.

In accordance with other aspects of the present invention, the fuel injector may, for example, be electronically actuated. An injector port may be provided for securing the fuel injector to the throttle body assembly, and a fuel rail assembly may be mounted to the throttle body assembly and coupled to the fuel injector for providing high-pressure fuel to be dispensed and distributed into the airflow.

In yet other aspects of the present invention, a throttle body injection system may include the throttle body assembly having an air conduit, an injector assembly coupled to the throttle body assembly, and a fuel deflector that deflects fuel dispensed from the injector assembly into an airflow path through the air conduit. In another exemplary aspect of the present invention, the throttle body injection system may be mounted to the intake manifold of an internal combustion engine.

In accordance with aspects of the present invention, a method of suspending fuel droplets in the airflow path of a throttle body assembly may include spraying fuel droplets from the nozzle of a fuel injector against a fuel dissemination device, or other dispersing or distributing feature, to disperse or otherwise deflectively disseminate the fuel droplets into an airflow path through the throttle body assembly.

Additional advantages and novel features of aspects of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 is a perspective view of a throttle body fuel distribution assembly with a partial cutout of an air intake chamber, in accordance with aspects of the present invention;

FIG. 2 is a plan view of a throttle body fuel distribution assembly with a partial cutout of an air intake chamber, in accordance with aspects of the present invention;

FIG. 3 is an exploded view showing components of a throttle body fuel distribution assembly, in accordance with aspects of the present invention; and

FIG. 4 is a perspective view of a throttle body fuel distribution assembly from the side of the assembly that attaches to a manifold, with a partial cutout of an air intake chamber, in accordance with aspects of the present invention.

### DETAILED DESCRIPTION

The detailed description may include specific details for illustrating various aspects of a throttle body fuel distribution assembly and related systems and methods. However, it will be apparent to those skilled in the art that aspects of the invention may be practiced without these specific details. In some instances, previously described or well known related elements may be shown in block diagram form, or omitted, to avoid obscuring the inventive concepts presented throughout this disclosure.

Various aspects of a throttle body fuel distribution assembly, for example, may be illustrated by describing components that are coupled together. As used herein, the term “coupled” is used to indicate either a direct connection between two components or, where appropriate, an indirect connection to one another through intervening or intermediate components. In contrast, when a component is referred to as being “directly coupled” to another component, there are no intervening elements present.

Relative terms such as “lower” or “bottom” and “upper” or “top” may be used herein to describe one element's relationship to another element from the perspective illustrated in the drawings. It will be understood that relative terms are intended to encompass different orientations of an apparatus in addition to the orientation depicted in the drawings. By way of example, if an apparatus in the drawings is turned over, elements described as being on the “bottom” side of the other elements would then be oriented on the “top” side of the other elements. The term “bottom” can therefore encompass both an orientation of “bottom” and “top” depending on the particular orientation of the apparatus.

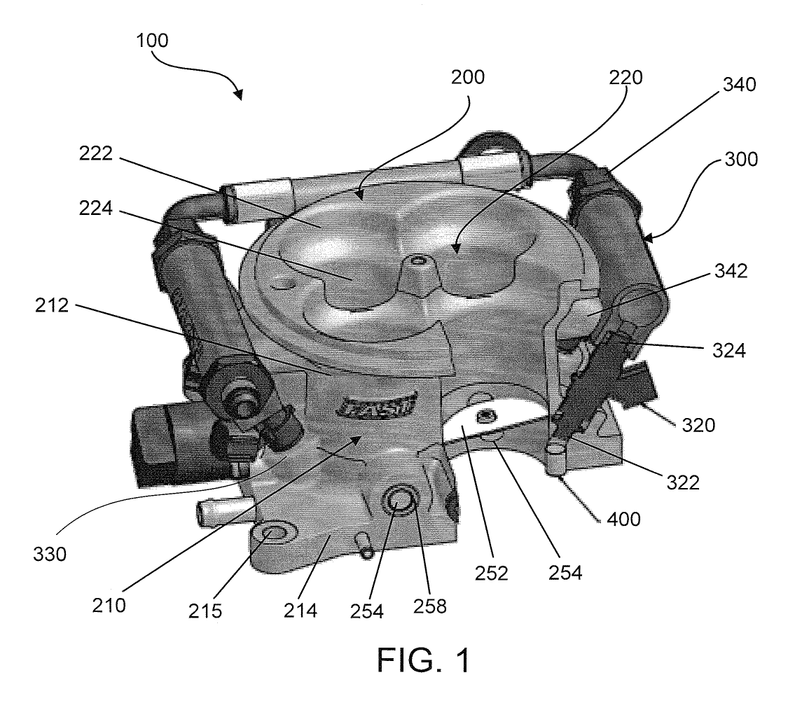

FIG. 1 shows a perspective view of a throttle body fuel distribution assembly 100, in accordance with aspects of the present invention. The throttle body fuel distribution assembly 100 includes a throttle body assembly 200, an injector assembly 300, and at least one fuel dissemination device 400. The throttle body assembly 200 includes a throttle body housing 210 that may be integrally formed with an air intake section 212 and a mounting plate 214. At least one throttle bore 220 provides an air intake conduit for directing airflow through the throttle body assembly 200 toward, for example, an air intake manifold for a combustion engine to which the assembly may be attached for operation, or directly toward one or more individual cylinders of the internal combustion engine, for example. The throttle bore 220 may be formed with an expanded induction section 222 that transitions into a narrower throat section 224 for accelerating the airflow as it is directed toward the intake manifold. Fastening holes 215 or other attachment features may be provided in the mounting plate 214 for coupling the throttle body assembly 200 to the air intake manifold.

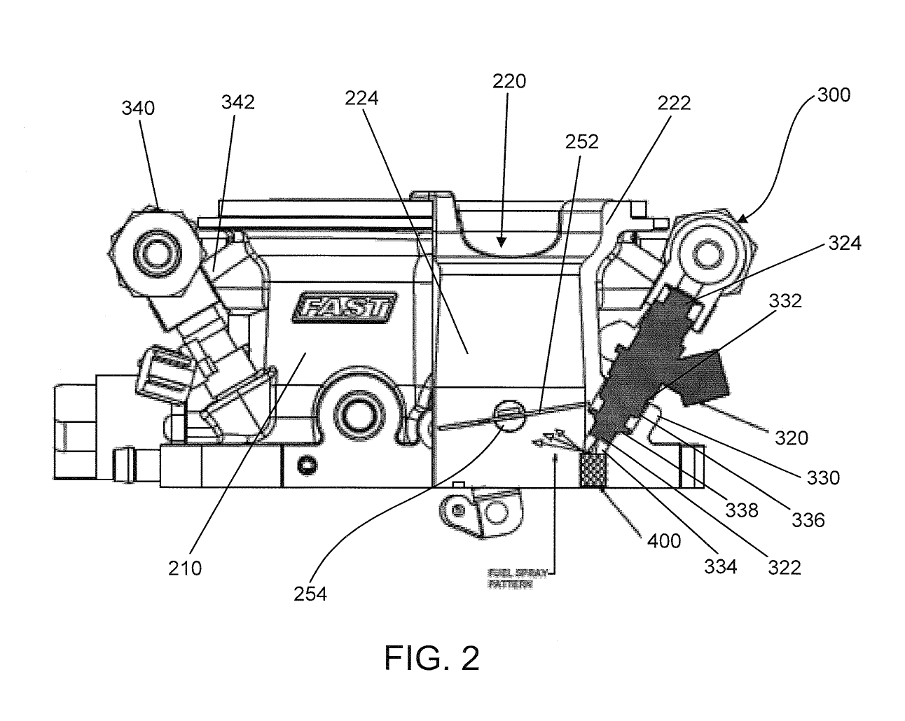

As shown in the cutaway portion of FIG. 1, and in the front view of FIG. 2, a throttle plate 252 may be positioned in the throttle bore 220, forming a throttle valve. The throttle plate 252 may be a flat plate capable of completely or substantially restricting or blocking the airflow through the throat section 224 of the throttle bore 220.

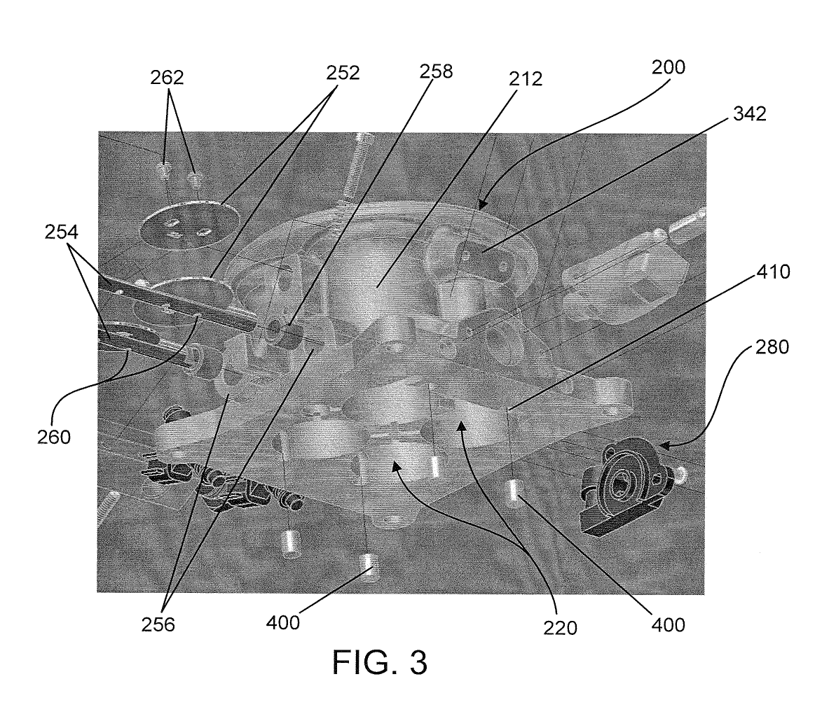

As shown in the exploded view of FIG. 3, the throttle plate 252 may be mounted to a rotatable shaft 254 or other position varying mechanism. For example, in the exemplary variation shown in FIG. 3, the shaft 254 inserts transversely through the air intake section 212 of the throttle body assembly 200. Shaft mounts 256, which may be integrally formed in the throttle body housing 210, may house shaft bearings 258 to rotatably support the shaft 254.

In accordance with aspects of the present invention, multiple throttle bores 220 may be provided in the throttle body assembly 200, which may, for example, have corresponding multiple shafts 254 with multiple throttle plates 252 mounted on any individual shaft 254. For example, FIGS. 1-4 illustrate an arrangement that includes two shafts 254 having two throttle plates 252 attached to each shaft 254, so as to allow positioning to control the airflow through four throttle bores 220.

The shaft 254 is mounted into the throttle body housing 210 by inserting the shaft 254 through the bearings 258 housed in the shaft mounts 256, for example. Once mounted, the shaft 254 extends diametrically through a radial center point of the throttle bore 220. As shown in FIG. 3, the shaft 254 may be provided with throttle plate mounts 260, which may include one or more internally threaded through holes, for example. With the shaft 254 extended through the throttle bore 220, the throttle plate 252 may be lowered into the throttle bore 220 and fastened to the shaft 254 using one or more securing features 262, such as screws.

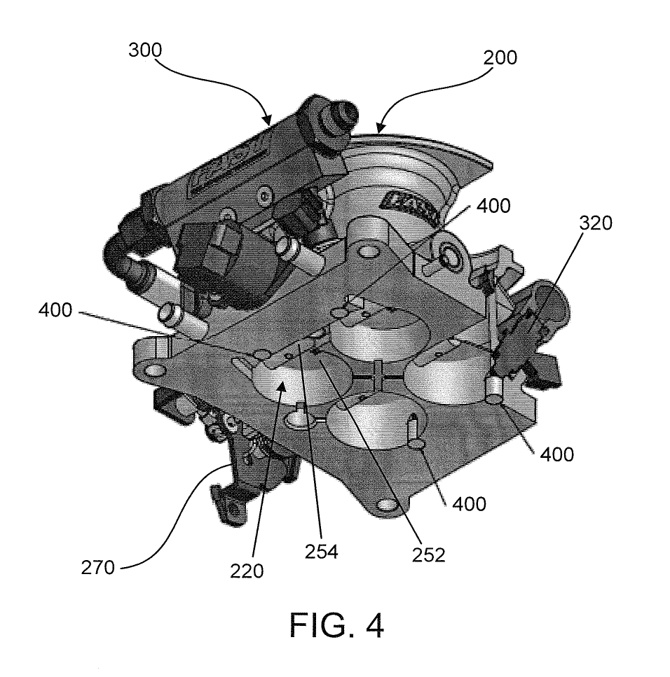

One end of the shaft 254 may be connected (e.g., mechanically or electrically) to an accelerator pedal by a throttle linkage assembly. For example, as shown in FIG. 4, the throttle linkage assembly may include a throttle bracket 270 connected to an accelerator pedal by a throttle cable (not shown). Movement of the accelerator pedal, by depression or release, for example, causes a corresponding movement in the throttle bracket 270, in turn resulting in a rotation of the shaft 254 connected to the throttle bracket 270. Rotation of the shaft 254 results in a corresponding rotation of the throttle plate 252 inside the throttle bore 220, which creates, enlarges, reduces, or closes peripheral gaps between the outer edge of the throttle plate 252 and an inner surface of the throttle bore 220 (e.g., see FIG. 2). Accordingly, airflow (e.g., volume and flow characteristics) through the throttle bore 220 into an intake manifold or an individual cylinder, for example, may be accurately metered by controlling the angle of rotation of the shaft 254.

As illustrated in FIG. 3, the opposite end of the shaft 254 from the end connected to the throttle bracket 270 may be connected to a throttle position sensor (TPS) 280. The TPS 280 accurately determines the angle of rotation of the shaft 254 and relays the corresponding position of the throttle plate 252 to an electronic control unit for a combustion engine, for example. In combination with various other sensors, for example, the electronic control unit may use the TPS reading to more accurately control the fuel into the intake manifold or cylinder in accordance with the changing demands of the engine.

As shown in FIGS. 1 and 2, the injector assembly 300 mounts to the throttle body assembly 200. In accordance with aspects of the present invention, at least one injector port 330, which may be integrally formed in the throttle body housing 210, provides a mount for attaching the injector assembly 300 to the throttle body assembly 200. The injector port 330 has a peripheral opening 332 that communicates with a recessed injection cylinder 334 by way of a cylindrical outer bore 336 and an injector seat 338. In the example shown, the cylindrical outer bore 336 and the recessed injection cylinder 334 are contiguous and concentrically arranged, with the cylindrical outer bore 336 having a larger inside diameter than the diameter of the recessed injection cylinder 334. As shown in the cutaway portion of FIG. 2, the fuel injector 320 may be inserted in the cylindrical outer bore 336 until the fuel injector 320 seats against the injector seat 338 with a nozzle end 322 of the fuel injector 320 pointing into the recessed injection cylinder 334 for dispensing a pressurized spray of fuel droplets into the airflow path downstream from the throttle plate 252. The injector port 330 may be formed to seat the fuel injector 320 at a predetermined angle.

The injector assembly 300 may include a fuel rail assembly 340. A distal end of the fuel injector 324 may connect to the fuel rail assembly 340 so that pressurized fuel may be delivered to the fuel injector 320. The pressurized fuel may be supplied to the fuel rail assembly 340 through a fuel line, for example, which is connected to a fuel pump and regulated by a pressure regulator to ensure a consistent pressurized source of fuel to the fuel injector 320. Fuel rail mounts 342 (see FIG. 3) may be provided on the throttle body housing 210 for mounting the fuel rail assembly 340 to the throttle body assembly 200, further securing the fuel injector 320 in the injector port 330.

The injector assembly 300 may be mechanically actuated, for example, or electronically actuated through the electronic control unit that controls the throttle valve. In the case of electronic actuation, the electronic control unit may receive information from an array of sensors, such as a Manifold Absolute Pressure (MAP) sensor, an oxygen sensor, and the throttle positioning sensor (TPS), and electrically actuate a solenoid in the fuel injector 320 to open the nozzle for a specific period of time in order to meter fuel into the airflow. The air-fuel ratio for combustion may thus be accurately and efficiently controlled in accordance with the desired engine operating conditions.

In conventional throttle body injection assemblies, the fuel spray is typically injected directly into the airflow path or the intake manifold, for example, upstream from the throttle valve. The distribution of the fuel spray in the airflow is often inconsistent, creating variations in the air-fuel ratio delivered to the various cylinders. The result is poor or inoperative engine performance, as some cylinders receive a rich fuel mixture, while other cylinders are starved of fuel.

To address this shortcoming, among others, and as shown in FIGS. 1-4, a fuel dissemination device 400, such as a distribution pin, may be press fit, for example, into a channel 410 that extends from a peripheral lower surface of the throttle body housing 210 through the mounting plate 214 and connects to the recessed injection cylinder 334. The dissemination device 400 may be formed to have certain contours or other features that affect fuel dispersion. In the example shown, the dissemination device 400 may be cylindrical in shape and provide an upper surface 402 that acts as a deflector and distributor of the fuel spray from the fuel injector 320.

As shown in FIG. 2, the dissemination device 400 may be sized to extend into the path of the fuel spray from the fuel injector 320. As the injected fuel spray hits the upper surface 402, the direction and force of the fuel spray may be diverted and dispersed, for example, in directions transverse and/or opposite the primary direction of airflow through the throttle bore 220. To enhance or direct the dispersion of the fuel spray, the upper surface 402 of the dissemination device 400 may include predetermined surface contours or have a predetermined surface roughness, for example, among other features. Accordingly, the fuel spray may be more appropriately dispersed and evenly distributed throughout the entire cross-sectional area of the airflow through the throttle bore 220 relative to related art assemblies that do not have such devices 400. For example, the flow pattern of the injected fuel spray as it is deflected against the dissemination device 400 is such that the deflected fuel droplets travel in a direction resistive to the natural airflow direction through the throttle bore 220. Thus, the deflected and dispersed fuel droplets reach a point at which the resistance of the airflow against the momentum of each droplet causes each droplet to reach a point at which the momentum is reduced to zero or substantially zero. The fuel droplets thus reach a point of momentary suspension in the throttle bore 220 prior to being carried away by the momentum of the airflow toward the intake manifold or cylinder head. The impact of the fuel spray against the devices 400, or any other suitable deflecting feature, enhances the distribution of the fuel droplets due to the varied directions and increased dispersion that results. The airflow characteristics and the predetermined features of the dissemination devices 400, for example, allow the suspended fuel droplets to be more evenly dispersed throughout the airflow and efficiently carried away toward the intake manifold and/or the individual cylinders.

Although described as a dissemination device 400 that is separately inserted into the throttle body fuel distribution assembly 100, the function of fuel distribution described herein may be accomplished by any suitable configuration of a surface having the predetermined size and shape required to divert the injected fuel into a zero momentum fuel droplet suspension. For example, the throttle body housing 210 may be integrally formed with a distribution surface in accordance with aspects of the present invention.

Example aspects of the present invention have now been described in accordance with the above advantages. It will be appreciated that these examples are merely illustrative of variations of the invention. Many other variations and modifications will be apparent to those skilled in the art.

What is claimed is:

1. A throttle body fuel distribution assembly comprising:
a throttle body assembly having a throttle body housing and a throttle bore for conducting an airflow;
a fuel injector coupled to the throttle body assembly; and
a fuel dissemination device, wherein a fuel spray from the fuel injector is dispersed by the fuel dissemination device into the airflow through the throttle bore.

2. The throttle body fuel distribution assembly of claim 1, wherein the fuel dissemination device comprises:
a distribution pin coupled to the throttle body assembly.

3. The throttle body fuel distribution assembly of claim 1, wherein the throttle body assembly further comprises:
a throttle valve assembly for controlling the airflow through the throttle bore.

4. The throttle body fuel distribution assembly of claim 3, wherein the throttle valve assembly comprises:
a throttle plate secured to a rotatable shaft, and wherein the shaft extends through the throttle bore.

5. The throttle body fuel distribution assembly of claim 4, further comprising:
shaft bearings mounted on the throttle body housing for supporting the rotatable shaft.

6. The throttle body fuel distribution assembly of claim 1, wherein the throttle body housing comprises an injector port for securing the fuel injector to the throttle body assembly.

7. The throttle body fuel distribution assembly of claim 6, wherein the injector port has a peripheral opening that communicates with a recessed injection cylinder via a cylindrical outer bore and an injector seat.

8. The throttle body fuel distribution assembly of claim 2, wherein the throttle body housing further comprises:
a channel, the channel securing the distribution pin in a predetermined position for dispersing the fuel spray.

9. The throttle body fuel distribution assembly of claim 1, further comprising:
a fuel rail assembly, wherein the fuel rail assembly is secured to the throttle body housing and communicates with the fuel injector.

10. The throttle body fuel distribution assembly of claim 1, wherein the fuel injector is electronically actuated.

11. The throttle body fuel distribution assembly of claim 1, wherein the fuel spray is deflected in a direction resistive to a direction of the airflow through the throttle bore.

12. A throttle body injection system for an internal combustion engine comprising:
a throttle body assembly having an air conduit that directs an airflow toward the engine;
an injector assembly coupled to the throttle body assembly for introducing fuel into the air conduit; and
a fuel deflector, wherein the fuel deflector disperses the fuel into the airflow through the air conduit.

13. The throttle body injection system of claim 12, wherein the fuel deflector comprises:
a distribution pin secured to the throttle body assembly.

14. The throttle body injection system of claim 12, wherein the throttle body assembly further comprises:
a throttle valve assembly for controlling the airflow through the air conduit.

15. The throttle body injection system of claim 12, wherein the throttle valve assembly comprises:
a throttle plate secured to a rotatable shaft, wherein the shaft extends through the air conduit.

16. The throttle body injection system of claim 12, wherein the injector assembly comprises:
a fuel injector.

17. The throttle body injection system of claim 16, wherein the fuel injector is electronically actuated.

18. The throttle body injection system of claim 12, further comprising:
an intake manifold, wherein the throttle body assembly is coupled to the intake manifold.

19. A method of suspending fuel droplets in the airflow path of a throttle body assembly, comprising:
supplying a pressurized source of fuel to a fuel injector; and
spraying the fuel from the fuel injector against a fuel dissemination device to disperse the fuel droplets into the airflow path.

20. The method of suspending fuel droplets in the airflow path of a throttle body assembly of claim 19, further comprising:
rotating a throttle plate positioned in the airflow path to control an airflow past the dispersed fuel droplets.

21. The method of suspending fuel droplets in the airflow path of a throttle body assembly of claim 20, wherein the fuel droplets are dispersed in a direction resistive to the airflow in the airflow path.
